(19) United States
(12) Patent Application Publication
(10) Pub. No.: US 2026/0193123 A1
(43) Pub. Date: Jul. 9, 2026

(54) HIGH-GENERATION TFT-LCD GLASS SUBSTRATE PREPARATION PROCESS

(71) Applicants: CNBM RESEARCH INSTITUTE FOR ADVANCED GLASS MATERIALS GROUP CO.,LTD., Bengbu (CN); BENGBU CHINA OPTOELECTRONIC TECHNOLOGY CO., LTD., Bengbu (CN); TRIUMPH SCIENCE & TECHNOLOGY GROUP CO., LTD., Beijing (CN); CHINA TRIUMPH INTERNATIONAL ENGINEERING CO., LTD., Shanghai (CN)

(72) Inventors: Shou PENG, Bengbu (CN); Chong ZHANG, Bengbu (CN); Congxiao WANG, Beijing (CN); Zhiqiang CAO, Bengbu (CN); Liangmao JIN, Bengbu (CN); Longyue JIANG, Bengbu (CN); Xueliang WU, Bengbu (CN); Tingrong SHAO, Bengbu (CN); Yaolong LIU, Shanghai (CN); Nan ZHENG, Beijing (CN); Nan ZHAN, Bengbu (CN); Mingliu ZHU, Bengbu (CN)

(21) Appl. No.: 19/556,105

(22) Filed: Mar. 4, 2026

Related U.S. Application Data
(63) Continuation of application No. PCT/CN2024/107490, filed on Jul. 25, 2024.

(30) Foreign Application Priority Data
Jul. 18, 2024 (CN) 202410965244.7

(51) Int. Cl. C03B 18/14; C03B 25/02; C03C 3/097

(52) U.S. Cl. CPC C03B 18/14; C03B 25/025; C03C 3/097

(57) ABSTRACT

Disclosed is a float preparation process for high-generation TFT-LCD glass substrates. The batching process is based on an optimized design of raw material formula, and blowing and vibration means are used to assist feeding to improve the homogeneity and stability of the composition. In a melting process, a three-dimensional gas-electric combined heating is carried out to achieve adequate melting. In a clarification process, platinum channel clarification and forced disturbance homogenization are adopted to complete efficient clarification and homogenization. A forming process improves the thinning quality by fine control over heating units and miniature edge rollers. An annealing process achieves fine annealing through independent zoning and precise annealing control. In a grinding process, specially designed grinding discs and grinding pads with chamfers, as well as the grinding pads with specific hardness, are used for grinding to achieve an excellent processing effect.

### CROSS-REFERENCE TO RELATED APPLICATIONS

This application is a continuation of International Patent Application No. PCT/CN2024/107490, filed on Jul. 25, 2024, which claims the benefit of priority from Chinese Patent Application No. 202410965244.7, filed on Jul. 18, 2024. The content of the aforementioned applications, including any intervening amendments thereto, are incorporated herein by reference.

### TECHNICAL FIELD

The present application relates to the field of glass substrate manufacturing and, in particular, to a float preparation process for high-generation TFT-LCD glass substrates.

### BACKGROUND

The electronic information display industry is an important pillar industry of China's national economy. China is the world's largest LCD panel producer, contributing to 70% of the world's total production capacity. High-generation TFT-LCD glass substrates are core materials and key strategic materials in the electronic information display industry and the pan-semiconductor industry. China's annual demand for high-generation TFT-LCD glass substrates exceeds 300 million square meters.

The quality and performance of high-generation TFT-LCD glass substrates have a crucial impact on the resolution, transmittance, refresh rate, viewing angle and other qualities of display panels. In view of this, there are extremely high requirements on the quality of the interior and surface of the substrate. Bubbles, stones, tin sticking, drips and scratches are strictly controlled indicators during the manufacturing process of glass substrates. Therefore, the production technology of advanced generation TFT-LCD glass substrates is complex, with production control accuracy equivalent to that of the semiconductor industry, representing the highest level in the field of modern large-scale manufacturing of glass in the world.

There are two main forming processes for high-generation TFT-LCD glass substrates: float process and overflow process. The float process has the advantages of large formed substrate width and low production costs, but it also has problems such as serious mutual influence among multiple processes, more control parameters, high difficulty in control, and high difficulty in stably controlling the production state. In addition, in the float process, molten glass is thinned and formed on the surface of molten tin metal. A contact surface between the molten glass and the surface of molten tin will have micro-defects such as tiny tin spots and scratches. This contact surface is also a processing surface for downstream LCD panel manufacturers. How to prepare micro-defect, high-quality, high-generation TFT-LCD glass substrates with excellent mechanical strength, thermal stability, thermal shrinkage and other properties and less surface and internal defects by the float process is an important technical problem that needs to be solved urgently.

### SUMMARY

In order to solve the technical problems existing in the prior art, based on long-term and large-team collaborative cooperation with unremitting efforts, the applicants carried out technological innovation in multiple processes of the display glass substrate production process, explored and utilized the advantages of each process, and carried out innovation research on combination of the processes. Finally, a breakthrough was achieved in the float process of high-generation TFT-LCD glass substrates, forming a display glass substrate production process that fully utilizes resources, complements advantages, and organically unifies production lines. Using this process, high-generation TFT-LCD glass substrates with excellent control indicators and performance indicators such as bubbles, stones, tin sticking, droplets and scratches can be prepared, effectively reducing or eliminating flaws in the glass substrates, greatly improving the quality of glass substrates, and providing solutions for the preparation of micro-defect, high-quality, high-generation display glass substrates.

The present application provides a preparation process for glass substrates. The preparation process includes the processes of batching, melting, clarification and homogenization, forming, annealing, grinding, cleaning, and packaging.

In the batching process, regarding the raw material composition, preferably, by selecting batch materials SiO₂, Al₂O₃, B₂O₃, MgO, CaO, SrO, ZrO₂, and P₂O₅ that are in a specific ratio, the boron volatilization rate can be effectively reduced during the glass forming process and the problem of uneven composition caused by boron volatilization can be eliminated. A aluminosilicate glass substrate prepared therefrom has high strain point, high Young's modulus, high hardness, appropriate thermal expansion coefficient, low thermal shrinkage, less flaws and other characteristics and meets the special requirements of high-generation TFT-LCD glass substrates.

Regarding the raw material batching method, an electronic scale feeding system that combines air nozzles for blowing with a pneumatic hammer for vibration is preferred. The raw materials are weighted in an electronic scale bucket, followed by feeding. When a pneumatic feeding valve is turned on, the air nozzles blow the inner wall of the electronic scale bucket, and the pneumatic hammer strikes and vibrates the electronic scale bucket, so that the raw materials retained on the inner wall of the electronic scale bucket are discharged synchronously. In this way, the constant composition of each batch material is ensured during the batching process, thereby ensuring the quality stability of the glass substrates.

In the melting process, a heating method that combines electric assisted melting and oxygen-fuel combustion is preferred. The electric heating may be implemented by virtue of molybdenum electrodes or tin oxide electrodes which may be arranged on the wall and/or bottom of a melting furnace. Burners may be arranged on the roof and/or breast wall of the melting furnace. Preferably, the melting furnace is equipped with a bubbling device and a furnace sill to perform primary bubble removal and clarification on the molten glass to remove bubbles with a diameter of at least 0.2 mm from the molten glass. The above arrangement promotes the synchronous heating of raw materials in the melting furnace, thereby fully and efficiently producing the molten glass. The primary bubble removal and clarification in the melting furnace can greatly help the removal of bubbles with a bubble diameter of at least 0.2 mm in the furnace section. After bubble removal, the number of bubbles in the molten glass with a bubble diameter of at least 0.2 mm is less than or equal to 0.1 bubble/kg. By subsequent precision clarification of platinum channels to remove bubbles with a bubble diameter of at most 0.2 mm, the bubble removal and clarification of the glass substrates are finally achieved, thus obtaining high-quality molten glass.

In the clarification and homogenization process, it is preferred to use a platinum channel composed of 2 or more high-temperature section platinum channels and one low-temperature section platinum channel for clarification, and optimized stirring and flow turbulence methods are implemented for forced homogenization. Relative to a single platinum channel, the reduced diameter of the platinum channel reduces the temperature difference of the molten glass on the same section of the channel. The improved flow disturbance process enhances the homogenization efficiency and promotes the good homogeneity of the molten glass flow in terms of temperature and composition. The lowering of the molten glass level reduces the floating distance of bubbles, and in combination with the optimized raw material formula, improves the efficiency of removing small bubbles. Through the special design of the clarification and homogenization process described above, the occurrence of defects such as bubbles and streaks on glass substrates is avoided, and bubbles in the molten glass are efficiently removed. The number of bubbles with a bubble diameter of at least 0.05 mm in the molten glass does not exceed 0.15 bubbles/kg.

During the forming process, it is preferred that gridded heating units are arranged at the top of a tin bath, and a plurality of miniature edge rollers are arranged in a forming and thinning zone. The heating units and the edge rollers are under collaborative control. By adjusting the output power of each heating unit in the lateral direction, the lateral temperature difference of the tin bath is adjusted, thereby realizing different viscosities of the glass ribbon in the lateral direction. In conjunction with the traction force of the appropriate main drive, the optimized combination of multiple miniature edge rollers to accurately control the thinning force achieves precision thinning of high-generation LCD glass substrates in the presence of multiple forces. The thickness difference of the entire high-generation TFT-LCD glass substrate prepared is less than or equal to 0.015 mm.

In the annealing process, it is preferred to adopt a three-dimensional grid annealing furnace structure with precise temperature control. Turbulence-free cooling air pipe cooling, low-conductivity ceramic roller conveying, barrier-based zone isolation, differential thermal insulation design for the annealing furnace and other methods are adopted to avoid air flow turbulence, reduce temperature field fluctuations, reduce the lateral temperature difference of the glass substrate, meet the requirements of constant and consistent lateral temperature of large-size ultra-thin glass substrate and precise match of temperatures in zones of the annealing furnace with the annealing curve of the substrate, achieve a perfect match between the temperature field and the annealing curve, and fully eliminate the stress on the glass substrate.

In the grinding process, three types of grinding pads (i.e., a rough grinding pad, a fine grinding pad and a polishing pad) in a hardness ratio of 90HD-100HD:60HD-70HD:35HD-40HD are used to grind and polish the glass substrate in turn, a width ratio of grinding surfaces other than those at the edge to grinding grooves is optimized, chamfers are made on the periphery of the grinding disc and at the outermost edge of each grinding pad away from the grinding disc, and the angle of the chamfer on the grinding disc is greater than or equal to the angle of chamfer on the grinding pad. In this way, the quality of grinding is improved, grinding scratches are reduced, and the grinding effect is improved.

The float process for preparation of high-generation TFT-LCD glass substrates finely controls the preparation process and achieves organic coordination of various production process procedures. By use of this process, we have taken the lead in realizing industrial and stable mass production of micro-defect, high-quality, high-generation float electronic glass substrates.

The beneficial effects of the invention: The invention fully explores and utilizes the advantages of multiple process procedures of the float production process for high-generation TFT-LCD glass substrates, conducts innovation research on combination of the process procedures, and forms a display glass substrate production process with organic unity, outstanding advantages, and good synergy and complementarity.

### BRIEF DESCRIPTION OF DRAWINGS

FIG. 1 is a schematic overall flowchart of a glass substrate preparation process;

FIG. 2 is a schematic diagram of a feeding system in a batching process;

FIG. 3 is a schematic front sectional view of a melting furnace in a glass raw material melting process;

FIG. 4 is a top view of a clarification and homogenization system in a clarification and homogenization process;

FIG. 5 is a schematic cross-sectional diagram of a tin bath in a forming process;

FIG. 6 is a schematic top view of a forming and thinning zone of the tin bath in the forming process;

FIG. 7 is a top view of an annealing furnace in an annealing process;

FIG. 8 is a schematic front sectional view of the annealing furnace in the annealing process;

FIG. 9 is a schematic diagram of a grinding process;

FIG. 10 is a schematic diagram of the surface of a glass substrate before and after grinding in the grinding process;

FIG. 11 is a schematic diagram of the structure of a grinding pad in the grinding process;

FIG. 12 is a schematic diagram of a grinding surface in the grinding process;

FIG. 13 is a schematic structural diagram of a grinding device in the grinding process;

FIG. 14 is an enlarged diagram of part A in FIG. 11;

FIG. 15 is a schematic diagram of a chamfer on a grinding disc in the grinding process; and

FIG. 16 is a schematic diagram of a chamfer on the grinding pad in the grinding process.

### DESCRIPTION OF EMBODIMENTS

The technical solutions in the embodiments of the present application will be described clearly and completely below in connection with the drawings of the present application, and it will be apparent that the embodiments described herein are merely some, not all of the embodiments of the present application. Based on the embodiments of the present application, all other embodiments obtained by those of ordinary skill in the art without creative work should fall within the scope of the present application. It should be appreciated that the drawings are only provided for reference and illustration and are not used to limit the present application.

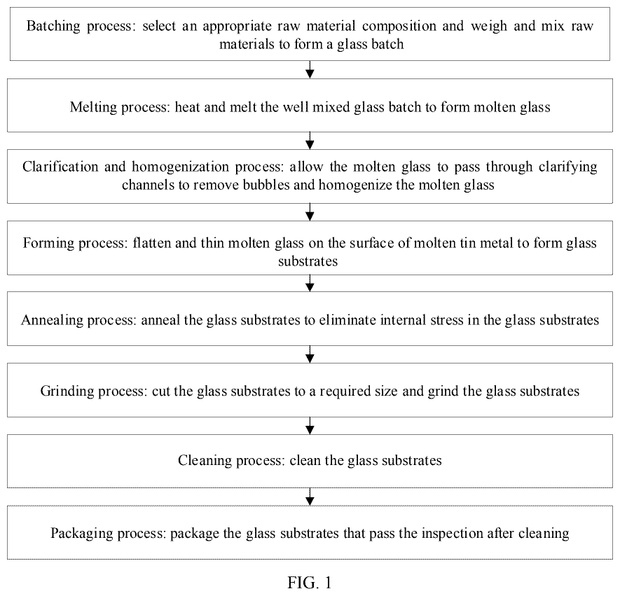

Specifically, embodiments of the present application provide a float process for preparation of high-generation TFT-LCD glass substrates. As shown in FIG. 1, the glass substrate preparation process mainly includes the following procedures:
batching process: selecting an appropriate raw material composition and weighing and mixing raw materials to form a glass batch;
melting process: heating and melting the well mixed glass batch to form molten glass;
clarification and homogenization process: allowing the molten glass to pass through clarifying channels to remove bubbles and homogenize the molten glass;
forming process: flattening and thinning molten glass on the surface of molten tin metal to form glass substrates;
annealing process: annealing the glass substrates to eliminate internal stress in the glass substrates;
grinding process: cutting the glass substrates to a required size and grinding the glass substrates;
cleaning process: cleaning the glass substrates; and
packaging process: packaging the glass substrates that pass the inspection after cleaning.

All the process techniques are detailed below one by one.

### Batching Process:

high-generation TFT-LCD glass substrates are required to have the following characteristics: low density, high strain point, appropriate thermal expansion coefficient, high Young's modulus, chemical attack resistance, low thermal shrinkage, and less micro-defects. To this end, the raw material composition needs to be carefully designed.

Preferably, materials, in the following percents by weight, are used: SiO₂: 60-72%; Al₂O₃: 13-18%; B₂O₃: 8.5-10%; MgO: 1-4.5%; CaO: 3-8%; SrO: 1-5%; ZrO₂: 0.5-2%; P₂O₅: 1-5%; SnO₂: 0.1-0.5%, wherein the amount of SiO₂+Al₂O₃ is 76-85%; the amount of (MgO+CaO+SrO)/Al₂O₃ is 0.4-0.7%; the total amount of alkaline earth metal oxides is 5-11.5%; the amount of B₂O₃/(B₂O₃+ZrO₂+P₂O₅) is 0.6-0.9%; the amount of (ZrO₂+P₂O₅)/(MgO+CaO+SrO) is 0.15-0.8%.

The glass formula may effectively reduce the boron volatilization rate during the glass forming process and control the problem of uneven glass composition caused by boron volatilization during the preparation process of glass substrates. In addition, the use of the raw materials may also promote the bubble removal and clarification of molten glass. The aluminosilicate glass substrate prepared from the raw materials has the characteristics of high strain point, high Young's modulus, high hardness, appropriate thermal expansion coefficient, low thermal shrinkage, less micro-defects and the like. The β-OH value is less than 0.5%, the boron volatilization rate is less than 11%, the thermal expansion coefficient in the range of 50-350° C. is less than 39.5×10⁻⁷/° C., the Young's modulus is greater than 78 GPa, the strain point is higher than 690° C., the melting temperature is lower than 1690° C., and the thermal shrinkage is less than 11.5 ppm.

Moreover, the quality requirements of high-generation TFT-LCD glass substrates are much higher than those of other types of glass. This requires very high homogeneity of the composition of the batch of high-generation TFT-LCD glass substrates without obvious differences in composition. Therefore, there are strict requirements on the purity, weighing accuracy, and mixing uniformity of various raw materials in the batch.

Preferably, the following electronic scale weighing system for controlling the stability of glass batch composition may be used.

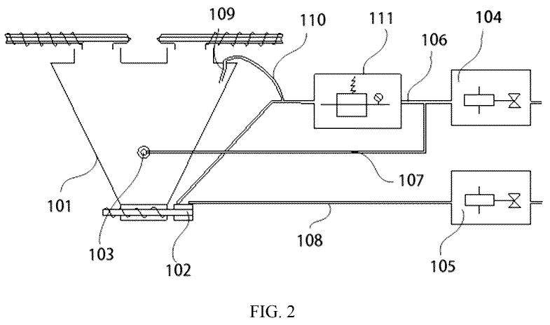

As shown in FIG. 2, the system includes an electronic scale bucket 101. A pneumatic feeding valve 102 is arranged at the bottom of the electronic scale bucket. A pneumatic hammer 103 is arranged on an outer wall of the electronic scale bucket 101. The pneumatic feeding valve 102 is controlled to open and close by an opening solenoid valve 104 and a closing solenoid valve 105 respectively. The opening solenoid valve 104 is also connected to the pneumatic hammer 103. The opening solenoid valve 104 is connected to a first air pipe 106 and a second air pipe 107. The first air pipe 106 is connected to the pneumatic feeding valve 102, and the second air pipe 107 is connected to the pneumatic hammer 103. The closing solenoid valve 105 is provided with a third air pipe 108, which is connected to the pneumatic feeding valve 102. An air nozzle 109 is arranged on an upper part of an inner wall of the electronic scale bucket 101. The air nozzle 109 is connected to a fourth air pipe 110 extending out of the electronic scale bucket 101, and the fourth air pipe 110 is in connection with the first air pipe 106. The air nozzle 109 may be provided in a place where material is often easily accumulated according to actual needs. If there are multiple places where material is accumulated, a plurality of air nozzles 109 are provided correspondingly. Through the system described above, the components in the glass raw material batch may be stably proportioned. Specifically, when the electronic scale bucket 101 works for feeding after weighing the glass raw materials, the pneumatic feeding valve 102 is opened and at the same time, the air nozzles 109 blow air to the inner wall of the electronic scale bucket 101, and the pneumatic hammer 103 strikes the electronic scale bucket 101, so that the raw materials retained on the inner wall of the electronic scale bucket 101 are discharged simultaneously, thereby ensuring that the composition of each batch material is stable in the liquid crystal glass batching process. In this way, the quality of the glass substrates is ensured.

By adopting the batching process described above, the quality and performance of the glass substrates are improved from the source, and the accuracy and stability of the batching are ensured.

### Melting Process:

After the above batching process is finished, the glass raw materials are melted by a melting process.

Preferably, the following melting process may be adopted.

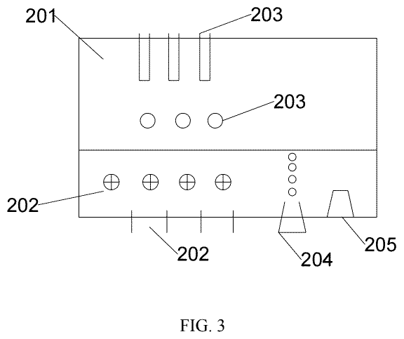

As shown in FIG. 3, electrodes 202 are symmetrically or staggered arranged on the inner walls of a melting furnace on two sides and/or at the bottom of the melting furnace, and oxygen-fuel combustion spray guns 203 are arranged on the roof and/or breast wall of the melting furnace 201. When arranged on the roof of the melting furnace, the oxygen-fuel combustion spray guns are vertically distributed, flame ports are vertically downward, and the flame can reach the liquid surface of the molten glass in the melting furnace 201. When arranged on the breast wall, the oxygen-fuel combustion spray guns are horizontally arranged. Through direct heating of electrodes and radiant heating of oxygen-fuel combustion, the glass raw materials are completely melted. Preferably, the melting furnace is also provided with a bubbling device 204 and a furnace sill 205 to perform primary bubble removal and clarification on the molten glass, thereby helping remove larger bubbles from the molten glass. Through the careful combination of raw materials, the use of all-round three-dimensional electric-gas-oxygen combustion combined heating method, and the effect of the bubbling device and the furnace sill, the number of bubbles with a bubble diameter of at least 0.2 mm in the molten glass is greatly reduced, and the number of bubbles with a bubble diameter of at least 0.2 mm is less than or equal to 0.1 bubble/kg.

Using the above process, the glass raw materials are heated at multiple angles from the bottom to the top, and the raw materials throughout the melting furnace are heated uniformly and adequately. Moreover, the special selection of glass raw materials promotes the coordination of the primary clarification of molten glass in the melting furnace with the precision clarification of molten glass in the clarification and homogenization section, enhances the bubble removal efficiency of the production line system, and improves the quality of glass substrates.

### Clarification and Homogenization Process:

The molten glass raw material becomes molten glass, which requires a clarification and homogenization process before forming.

Preferably, the following process may be used for clarification and homogenization.

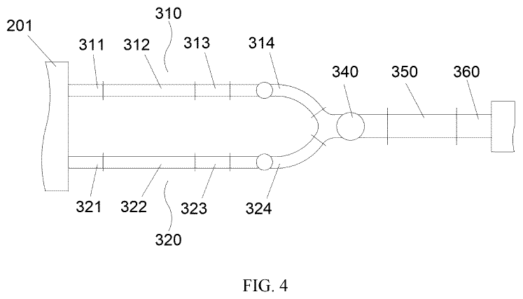

As shown in FIG. 4, the platinum channel includes a plurality of high-temperature section platinum channels and one low-temperature section platinum channel (a post-confluence stirring section, a second cooling section and a feeding section). A first inlet section (311), the first clarifying section (312), a first cooling section A (313) and a first stirring section (314) are connected in sequence to form the first high-temperature section platinum channel (310). A second inlet section (321), a second clarifying section (322), a first cooling section B (323) and a second stirring section (324) are connected in sequence to form the second high-temperature section platinum channel (320). Ports of the first inlet section (311) and the second inlet section (321) are connected to the melting furnace (201), and ports of the first stirring section (314) and the second stirring section (324) are connected to the post-confluence stirring section (340). A low-temperature section platinum channel composed of a second cooling section (350) and a feeding section (360) is also connected in turn to the post-confluence stirring section (340), and the feeding section (360) is connected to a tin bath; The first cooling section A (313) and the first cooling section B (323) are configured to cool the molten glass flowing through and control the cooling rate to achieve the process temperature required by the stirring section. The second cooling section (350) is also configured to cool the molten glass flowing through, and at the same time, heat the molten glass flowing through when necessary to meet the requirements of glass forming. Grills with different installation angles are sequentially arranged inside the second cooling section (350) from right to left. The installation angles of adjacent grills are different, causing misalignment of holes in the grills to ensure that the molten glass passes through the grills to form turbulence.

The multi-platinum channel clarification and homogenization process described above reduces the thermal load on a single platinum channel and avoids the risk of collapse of large-diameter platinum channels due to long-term high-temperature operation. The platinum channel with a reduced diameter reduces the difference between the center temperature of the molten glass and the temperature at the contact point of the platinum body on the same section of the channel. The improved stirring and grid turbulence processes improve the homogenization efficiency and enhance the homogeneity of the molten glass. Through this homogenization process, the temperature and composition of the glass liquid can be fully homogenized, thereby improving the quality of the glass substrates. Due to the reduction of the liquid level of the molten glass, the bubble removal efficiency of small bubbles is improved, and the number of bubbles with a bubble diameter of at least 0.05 mm in the molten glass does not exceed 0.15 bubbles/kg. The coordination of raw material selection, primary clarification in the furnace, and precision clarification and homogenization can remove bubbles from the molten glass with high quality.

### Forming Process:

After the above clarification and homogenization process is finished, the molten glass is subjected to float thinning and forming.

Preferably, the following process may be used for float thinning and forming.

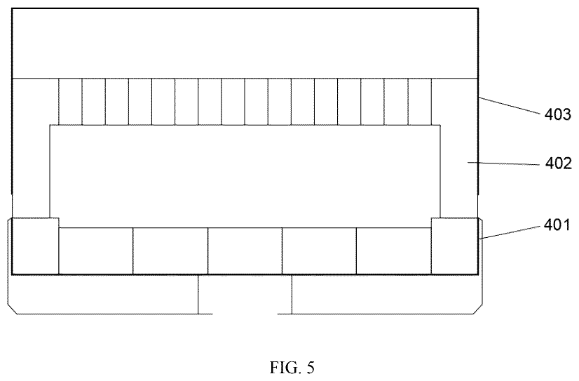

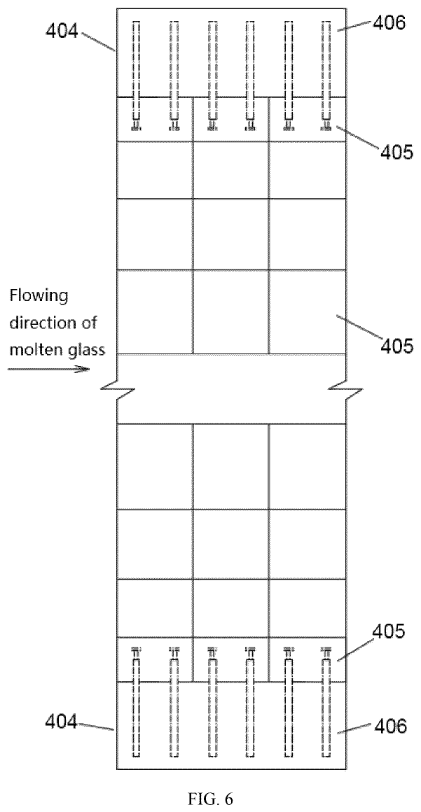

As shown in FIGS. 5 and 6, molten glass flows into the forming tin bath. The tin bath is divided into a bath body 401, a breast wall 402 and a top cover 403 from bottom to top. In the flow direction of the molten glass, the tin bath is divided into a forming and thinning zone 404, a shaping and cooling zone and a temperature homogenization zone.

The top of the tin bath is divided into a plurality of gridded heating units 405 with the flow direction of the molten glass as a longitudinal direction and the direction perpendicular to the flow direction of the molten glass as a lateral direction. Each heating unit is capable of independently controlling the heating temperature. Each heating unit includes one or more heating elements. The TFT-LCD glass substrate has the characteristics of high forming temperature and volatile components. For this reason, a preferred heating element is a high-density three-phase silicon carbide rod.

It is preferred to increase the density of gridded heating units in the forming and thinning zone, so that the temperature in each zone is more finely controlled, thereby improving the accuracy and flexibility of temperature control.

In conjunction with the tin bath heating system, it is preferred to use a precision thinning system in the forming and thinning zone for collaborative control. TFT-LCD glass has short liquid properties and a small forming temperature range. In view of this, the spacing between edge rollers is reduced and the number of edge rollers is increased. In a limited temperature range, the working range of the thinning system is reduced, and the thinning force of a glass ribbon may be finely distributed to each pair of edge rollers to achieve ultra-thin precision forming of glass substrates. The precision thinning system adopts miniature edge rollers 406. The body of the each edge roller is less than 300 mm, preferably 200-250 mm; the distance between two adjacent edge rollers is less than 1000 mm, preferably 500-900 mm. A total of 15 to 25 pairs of edge rollers are provided in the forming and thinning zone. Preferably, 18 to 22 pairs of edge rollers are provided.

Preferably, at least some of heating units 415 on the edge in the lateral direction are provided corresponding to the edge rollers, and one heating unit on the edge corresponds to one to four edge rollers, preferably two to three edge rollers.

The heating units and the edge rollers are adjusted by a control system. By adjusting the output power of each heating unit in the lateral direction, the lateral temperature difference of the tin bath is adjusted, thereby adjusting the lateral viscosity difference of the glass ribbon. The thinning force of the edge rollers acts on the edge of the glass ribbon and is transmitted to the middle of the glass ribbon. The influence of the adjustment of the lateral temperature difference in the tin bath on the viscosity of the molten glass is coupled with the control of the thinning force of the edge rollers, thereby improving the lateral thinning effect of the glass ribbon and achieving a thickness difference of less than or equal to 0.015 mm for the entire high-generation TFT-LCD glass substrate.

### Annealing Process:

After the above float forming is finished, the formed glass substrate needs to be annealed.

Preferably, the following glass annealing process may be adopted.

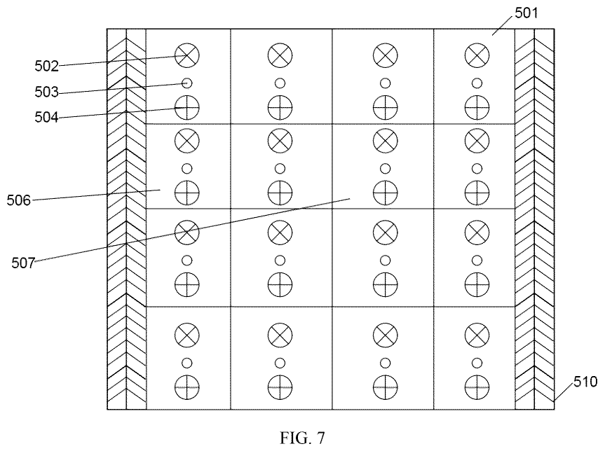

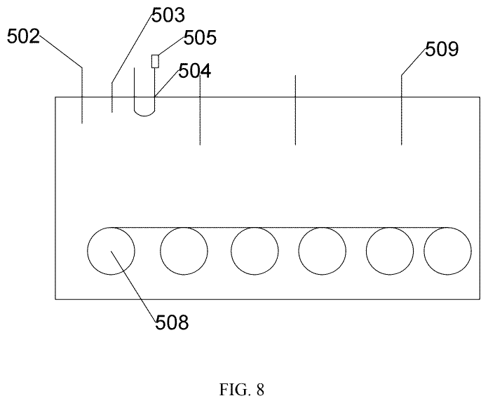

As shown in FIGS. 7 and 8, a grid control method is used in the annealing process. An annealing zone is divided into multiple subzones 501, and each subzone 501 may be subject to independent temperature control. Each subzone includes a temperature detection device 502, a heating device 503 and a cooling device 504. The cooling device is configured as a cooling air pipe, with an air inlet arranged on the outside of the furnace body and an air outlet provided with a centrifugal fan 505. By the air flowing in the cooling air pipe, the temperature of the cooling air pipe is reduced, and the cooling air pipe reduces the temperature of each subzone. In this way, air disturbance is avoided.

It is found through research that one of the reasons for the poor mechanical properties of liquid crystal glass substrates is large internal stress in the lateral direction of the same glass substrate, which is caused by inconsistent lateral annealing temperatures. Since the temperature at the edges of the glass substrate in the lateral direction is lower than the temperature at the middle, if the temperature is not differentially controlled, it will easily lead to different lateral annealing temperatures and cause the problem of large internal stress. In view of this, it is preferred that in at least part of the annealing area, the temperature of subzones 506 corresponding to the edges of the glass is higher than the temperature of the subzones 507 corresponding to the center of the glass.

Preferably, ceramic rollers serve as transfer rollers 508. The ceramic rollers have excellent thermal insulation effect, thereby preventing heat conduction between the glass substrate and the ceramic rollers to the greatest extent and avoiding unexpected temperature reduction of the glass substrate. Barriers 509 are arranged in the annealing furnace. The barriers may be controlled to rise and fall. Unlike other float glasses, ultra-thin glass is transferred at a faster speed in the annealing furnace. During the transfer process, air flow is easily formed. The use of the barriers avoids the flow of air flow, which is more conducive to the independence and precise temperature control of the zones.

Further preferably, the thermal insulation layer has different temperatures from the inner side to the outer side, with the temperature at the inner side being higher and the temperature at the outer side being lower. By arranging thermal insulation materials with different heat conductivities in the heat transfer direction of the thermal insulation layer, a thermal insulation material with lower heat conductivity is applied to an inner high-temperature layer 510 to reduce the overall heat conductivity. Further, thermal bridges such as connecting plates and tapholes between the inner and outer walls of the annealing furnace are thermal broken bridges for connection to further reduce heat conduction. The temperature difference between an outer wall and the environment drops to less than ⅔ of the original temperature difference between the outer wall and the environment. By the above measures, temperature fluctuations caused by frequent temperature adjustments can be avoided and temperature stability in the annealing furnace can be improved.

The temperature detection device, heating device, cooling device, and barrier lifting device in each subzone are all connected to a control device and are controlled by the control device in an automatic and intelligent manner.

The annealing process of the present application can better meet the requirement for precise matching between the temperature field and the annealing curve of the high-generation TFT-LCD glass substrate, reduce the lateral temperature difference of the glass substrate, avoid fluctuations and disturbances in the temperature field, effectively eliminate the internal stress of the glass substrate, thereby achieving differentiated, refined, automated and intelligent annealing control.

### Grinding Process:

After glass annealing, the glass substrates need to be ground. Grinding refers to grinding rough parts of the glass surface and micro-defects such as tin sticking and scratches. By adding chemical components such as abrasives and additives, the glass surface may be made smooth and flat to achieve the grinding effect.

Polishing is carried out after preliminary grinding to further smooth the glass surface and improve the flatness of the glass surface.

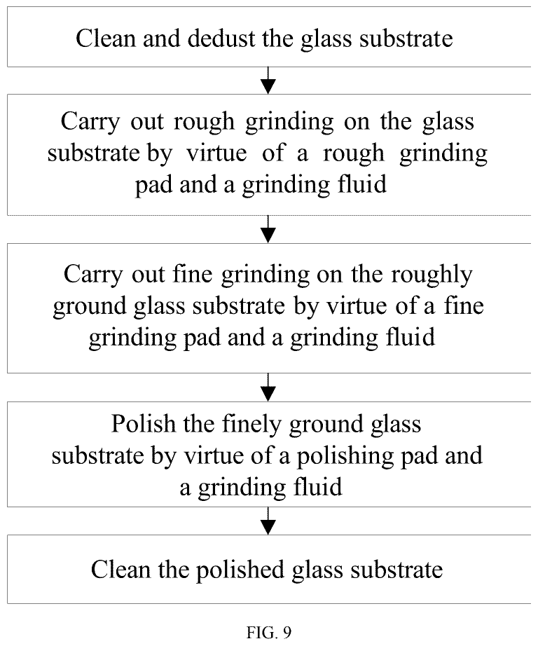

As shown in FIG. 9, the grinding process in this embodiment is mainly carried out in the following way:
cleaning and dedusting the glass substrate;
carrying out rough grinding on the glass substrate by virtue of a rough grinding pad and a grinding fluid;
carrying out fine grinding on the roughly ground glass substrate by virtue of a fine grinding pad and a grinding fluid;
polishing the finely ground glass substrate by virtue of a polishing pad and a grinding fluid; and
cleaning the polished glass substrate.

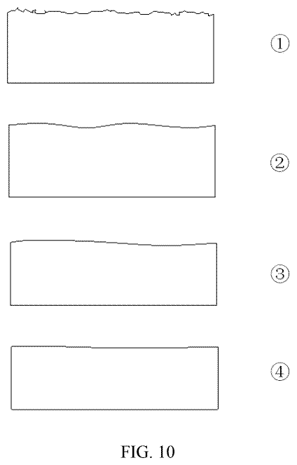

An unground glass surface takes on the state shown in \textcircled{1} in FIG. 10. The glass surface has many irregular states and structures, and the irregular states and structures will lead to a decrease in the light transmittance of the glass and image distortion.

Before grinding, the glass needs to be cleaned and dedusted.

During grinding, the rough grinding pad provided on a grinding member, together with the grinding fluid, grinds the glass substrate from the state shown in \textcircled{1} in FIG. 10 to the state shown in \textcircled{2} in FIG. 10 to eliminate rough areas of the glass substrate.

After the rough grinding is finished, the fine grinding pad provided on the grinding member, together with the grinding fluid, grinds the glass substrate to remove extremely fine scratches from the glass substrate, and the glass substrate is ground from the state shown in \textcircled{2} in FIG. 10 to the state shown in \textcircled{3} in FIG. 10.

After the fine grinding is finished, the polishing pad provided on the grinding member, together with the grinding fluid, grinds the glass substrate at a deeper level. After the glass substrate is ground with the polishing pad, defects on the glass substrate that are invisible to the naked eye are eliminated by polishing, and the glass substrate is ground from state \textcircled{3} in FIG. 10 to state \textcircled{4} in FIG. 10, which meets the high quality requirements on TFT-LCD glass substrates.

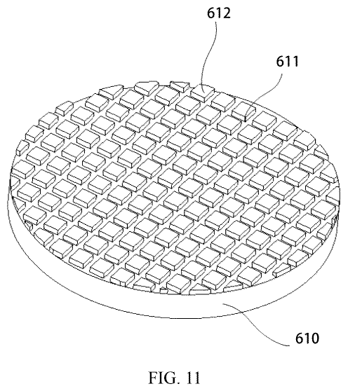

A grinding device used during the grinding process is as shown in FIGS. 11-14. The grinding device includes a grinding disc 620 and a grinding pad 610. The grinding pad 610 is mounted on the grinding disc 620. a surface of the grinding pad 610 that is far away from the grinding disc 620 is used for grinding glass. Each grinding pad is composed of a grinding baseplate 614 and an abrasive particle layer 613. The abrasive particle layers 613 on different grinding pads 610 have different hardness.

Regarding the hardness range, the hardness ratio of the rough grinding pad:the fine grinding pad:the polishing pad is preferably controlled to be 90HD-100HD:60HD-70HD:35HD-40HD, and more preferably 90HD-95HD:60HD-70HD:

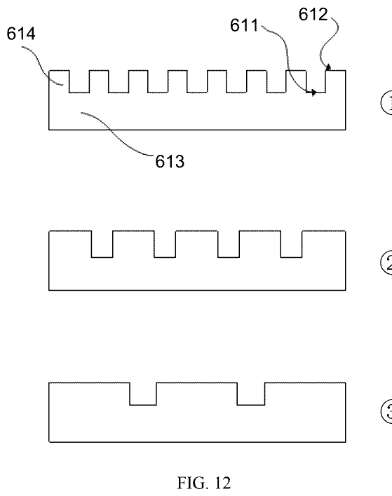

35HD-40HD, and more preferably 90HD-95HD:65HD-70HD:35HD-40HD. As used above, HD refers to the Shore hardness indicator. As shown in FIGS. 11 and 12, in order to improve the grinding effect, grinding grooves 611 are formed in the grinding pad 610, and the plurality of grinding grooves 611 are in connection with each other to facilitate the flowing of the grinding fluid. A plurality of grinding surfaces 612 are formed on the grinding pad 610. Preferably, the grinding surfaces other than those at the edge are square, and the grinding surfaces 612 grind the surface of the glass substrate.

The width ratio of the grinding surfaces other than those at the edge to the grinding grooves is preferably 1:1-3:1, and further preferably 1.7:1-2.3:1.

In the embodiments of the present application, the matching relationship between the grinding pad 610 and the grinding disc 620 may also have an impact on the grinding effect of the glass substrate. The impact is mainly that the working surfaces at the edge of the grinding pad 610 and the processing surface of the glass substrate are not completely parallel during the grinding process.

In the prior art, the edge of the grinding pad is basically vertical to the processing surface. Due to this structure, during the grinding process, the edge of the grinding pad may scratch the glass substrate to a certain extent, and the scratch will lead to the generation of wear marks on the glass.

After many simulations and research, it is found that the specially designed double chamfer coupling can greatly reduce the probability of scratching the glass substrate by the grinding pad during grinding. The specific implementation is as follows:

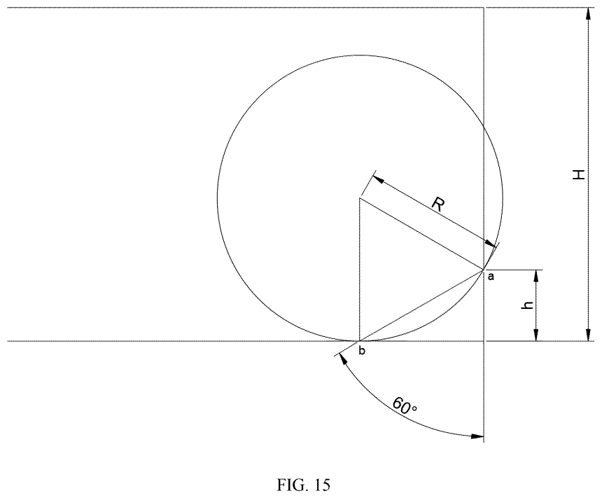

Round chamfer processing is performed on the periphery of the grinding disc 620. In the embodiments of the present application, the round chamfer is a round chamfer 621. The round chamfer is made as follows: as shown in FIG. 15, taking the height of the side surface of the grinding disc as H, extending the bottom surface of the grinding disc vertically upward along the side surface for a distance h to reach point a, taking the side surface of the grinding disc as one side, point a as an angular vertex, the angle of the round chamfer as the other side, the intersection point of the other side and the bottom surface of the grinding disc as point b, connecting points a and b to form a side, an isosceles triangle is formed, and the side length of the isosceles triangle is the radius R of the round chamfer. h/H=1:2-1:6, preferably 1:3-1:5, more preferably 1:3.5-1:5.

Preferably, the periphery of the grinding pad is chamfered close to the periphery of the grinding disc 620.

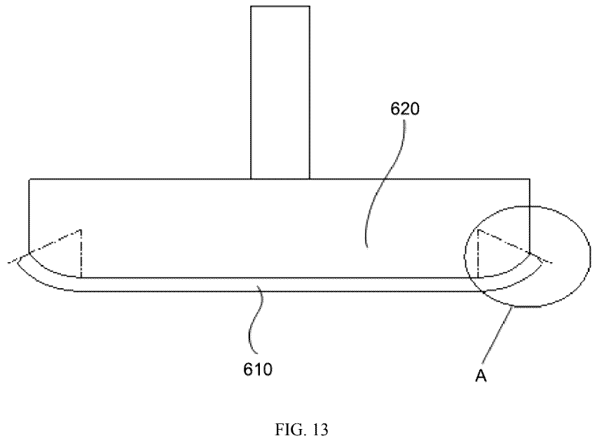

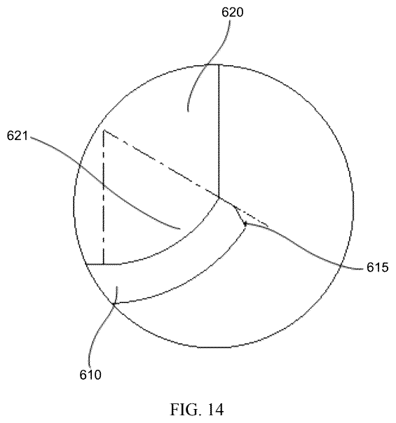

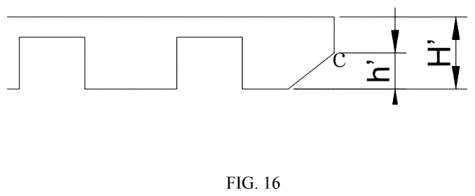

Moreover, as shown in FIGS. 13 and 14, a chamfer is also made at the outermost edge of the grinding pad far away from the grinding disc 620, i.e., at the position towards the glass substrate. Preferably, the chamfer is a straight chamfer 615. The forming of the straight chamfer 615 can further avoid scratching the glass substrate in combination with the round chamfer 621. As shown in FIG. 16, the straight chamfer is at position c on the side surface of the grinding pad, the distance from the position c to the bottom surface of the grinding pad is h′, and the thickness of the side surface of the grinding pad is H′, h′/H′=4:5-1:2, preferably 4:5-3:5. Regarding the relationship between the angle of the chamfer on the grinding disc and the angle of the chamfer on the grinding pad, it is preferred that the angle of the chamfer on the grinding disc is greater than or equal to the angle of the chamfer on the grinding pad; it is further preferred that the angle of the chamfer on the grinding disc is greater than or equal to the angle of the chamfer on the grinding pad and the angle of the chamfer on the grinding disc is greater than or equal to 50°; it is further preferred that the angle of the chamfer on the grinding disc is greater than or equal to the angle of the chamfer on the grinding pad and the angle of the chamfer on the grinding disc is greater than or equal to 60°; it is still further preferred that the angle of the chamfer on the grinding disc is greater than or equal to the angle of the chamfer on the grinding pad and the angle of the chamfer on the grinding disc is greater than or equal to 60° but less than or equal to 75°.

The glass grinding fluid is a material that plays an important role in glass manufacturing and processing. The grinding fluid is mainly composed of an abradant, a solvent and other additives. These components are suspended in a liquid in the form of particles. The main function of the glass grinding fluid is to remove impurities from the glass surface by grinding particles to achieve a smooth glass surface. The glass grinding fluid used in the present application preferably comprises cerium oxide, lanthanum oxide, fluoride, praseodymium oxide, silicon oxide, aluminum oxide, calcium oxide and iron oxide, with a concentration ranging from 1% to 10%.

In embodiments of the present application, in order to improve the grinding effect, the grinding pressure, grinding temperature and grinding speed may be controlled.

The grinding pressure may be controlled between 0.01 MPa and 0.3 MPa, preferably between 0.01 MPa and 0.28 MPa, further preferably between 0.1 MPa and 0.25 MPa, still further preferably between 0.1 MPa and 0.2 MPa, and most preferably between 0.15 MPa and 0.2 MPa.

The grinding temperature may be controlled within a range of 20° C. to 60° C., preferably between 20° C. and 50° C., further preferably between 30° C. and 50° C., and still further preferably between 30° C. and 40° C.

The grinding speed may be controlled between 5000 rpm and 7000 rpm, preferably between 5200 rpm and 6500 rpm, further preferably between 5500 rpm and 6300 rpm, and still further preferably between 5800 rpm and 6000 rpm.

The grinding time may be controlled between 30 s and 300 s, preferably between 60 s and 240 s, and more preferably between 80 s and 150 s.

### Cleaning Process:

After the above processes are finished, the glass substrates need to be cleaned. The cleaning process is mainly to remove residual grinding fluid and other impurities from the surface of the glass substrates, so as to facilitate later testing of the roughness of the glass substrates using a Surtronic S-100 series surface roughness tester.

The glass substrates are subjected to deep combined cleaning by disc brushing, roller brushing, ultrasonic cleaning, two-fluid cleaning and the like to achieve the purpose of cleaning the glass surface.

### Packaging Process:

Glass substrates that pass the inspection after cleaning are packaged to avoid affecting the sales of the glass on the market due to cracks and breaks caused by collision.

### Embodiments

The Embodiments section of the present application focuses on the grinding process of the invention.

The grinding fluid in the embodiments is made of abrasive powder mainly composed of cerium oxide (the content of cerium oxide is 58%) and 0.2 MΩ of pure water, with a concentration range of 4%. In the following grinding process, grinding is carried out based on the composition of the glass grinding fluid. For the grinding disc, h/H=1:4, h=4 mm; for the grinding pad, h′/H′=¾.

In embodiments of the present application, the hardness range of the rough grinding pad is between 90HD and 100HD, the hardness range of the fine grinding pad is between 60HD and 70HD, and the hardness range of the polishing pad is between 35HD and 45HD. Through the cooperation of the grinding pads 610 with different hardness, different effects of glass surface flatness can be produced.

In the embodiments of the present application, the grinding pressure is 0.15 MPa, the grinding temperature is 35° C., the grinding speed is 6000 rpm, and the grinding time is 140 s.

Roughness is tested by a Surtronic S-100 series surface roughness tester.

The grinding effects of the combination of multiple grinding pads with different hardness are shown in Table 1 below:

TABLE 1

| | Hardness combination | | | | |
|---|---|---|---|---|---|
| | of grinding pads | | | Flatness | defective |
| | Rough | Fine | | compliance | scratch |
| No. | grinding | grinding | Polishing | rate | rate |
| 1 | 100 | 70 | 45 | 88.8% | 2.52% |
| 2 | 95 | 70 | 45 | 95.6% | 2.33% |
| 3 | 90 | 70 | 45 | 86.37% | 1.98% |
| 4 | 100 | 65 | 45 | 89.30% | 2.33% |
| 5 | 100 | 60 | 45 | 90.17% | 2.47% |
| 6 | 95 | 65 | 45 | 92.52% | 1.55% |
| 7 | 95 | 60 | 45 | 96.52% | 1.54% |
| 8 | 90 | 65 | 45 | 95.53% | 1.47% |
| 9 | 90 | 60 | 45 | 90.52% | 1.25% |
| 10 | 100 | 70 | 35 | 91.6% | 0.15% |
| 11 | 95 | 70 | 35 | 97.58% | 0.11% |
| 12 | 90 | 70 | 35 | 96.65% | 0.09% |
| 13 | 100 | 65 | 35 | 95.53% | 0.15% |
| 14 | 100 | 60 | 35 | 94.78% | 0.08% |
| 15 | 95 | 65 | 35 | 98.54% | 0.02% |
| 16 | 95 | 60 | 35 | 98.01% | 0.01% |
| 17 | 90 | 65 | 35 | 98.56% | 0.05% |
| 18 | 90 | 60 | 35 | 96.88% | 0.05% |
| 19 | 100 | 70 | 40 | 93.97% | 0.08% |
| 20 | 95 | 70 | 40 | 99.98% | 0.02% |
| 21 | 90 | 70 | 40 | 98.32% | 0.03% |
| 22 | 100 | 65 | 40 | 94.03% | 0.05% |
| 23 | 100 | 60 | 40 | 94.52% | 0.06% |
| 24 | 95 | 65 | 40 | 99.66% | 0.03% |
| 25 | 95 | 60 | 40 | 99.50% | 0.04% |
| 26 | 90 | 65 | 40 | 95.37% | 0.03% |
| 27 | 90 | 60 | 40 | 96.50% | 0.04% |

The flatness refers to the degree of deviation between the geometric shape of the surface of a glass substrate and an ideal plane. The flatness is usually expressed by a distance between two points or the radius of curvature. The flatness of the high-generation TFT-LCD glass substrate has great impact on the strength, optical properties, physical properties and other aspects of the glass substrate. Therefore, during the manufacturing process, flatness needs to be strictly controlled and tested. The defective scratch rate of glass mainly refers to the probability that the scratches caused during the surface forming and processing of the semi-finished glass substrate are not completely eliminated after grinding. The lower the defective scratch rate, the less scratches will be left on the glass surface after grinding.

Referring to Table 1 above, when the hardness ratio of the rough grinding pad:the fine grinding pad:the polishing pad is 90HD-100HD:60HD-70HD:35HD-40HD, the glass substrates have good performance in terms of flatness compliance rate and defective scratch rate after grinding; when the hardness ratio of the rough grinding pad:the fine grinding pad:the polishing pad is 90HD-95HD:65HD-70HD:35HD-40HD, the glass substrates have better performance in terms of flatness compliance rate and defective scratch rate after grinding.

In the embodiments of the present application, the width ratio of the grinding surfaces 612 other than those at the edge to the width of the polishing groove 611 is set to a proportional relationship of 1:1-3:1, and any grinding pad that conforms to this proportional relationship can better complete the grinding of the glass substrates. After a large number of experiments and research, it is found that:
compared with the most preferred solution, when the width ratio of the grinding surfaces 612 other than those at the edge to the width of the polishing groove 611 is 1:1-1.7:1, the flow guiding effect is good, the grinding fluid flows fast, but the grinding contact area is small, and the grinding efficiency is relatively low;
when the width ratio of the grinding surfaces 612 other than those at the edge to the width of the polishing groove 611 is 1.7:1-2.3:1, the flow guiding effect of the grinding fluid and the grinding efficiency are both good, ensuring the grinding efficiency without causing secondary defects;
compared with the most preferred solution, when the width ratio of the grinding surfaces 612 other than those at the edge to the width of the polishing groove 611 is 2.3:1-3:1, the grinding efficiency is high, but the flow guiding effect and the fluidity of the grinding fluid are poor, and the probability of causing secondary defects is relatively high.

Therefore, according to the test results, when the width ratio of the grinding surfaces 612 other than those at the edge to the width of the polishing groove 611 is 1.7:1-2.3:1, as shown in \textcircled{2} in FIG. 12, the flow guiding effect of the grinding fluid and the grinding efficiency are both good, thereby better meeting the requirements for manufacturing high-quality glass substrates.

For the selection of round chamfers and straight chamfers, the changes in the occurrence rate of wear marks on glass caused by different angles are shown in Table 2:

TABLE 2

| | Angle of | Angle of | Occurrence |
|---|---|---|---|
| | chamfer on | chamber on | rate of |
| No. | grinding disc | grinding pad | wear marks |
| 1 | 0 | 45 | 100% |
| 2 | 30 | 45 | 30% |
| 3 | 45 | 45 | 25% |
| 4 | 60 | 45 | 3% |
| 5 | 75 | 45 | 5% |
| 6 | 30 | 60 | 28% |
| 7 | 45 | 60 | 26% |
| 8 | 60 | 60 | 2.8% |
| 9 | 75 | 60 | 8% |
| 10 | 30 | 30 | 15% |
| 11 | 45 | 30 | 10% |
| 12 | 60 | 30 | 0% |
| 13 | 75 | 30 | 1% |

According to the data in the above table, when the angle of the chambers on the grinding disc is greater than or equal to the angle of the chamfer on the grinding pad, and the angle of the chambers on the grinding disc is greater than or equal to 60°, the occurrence rate of wear marks is low and a better grinding effect is achieved.

The above embodiments are only used to illustrate the technical methods of the invention instead of limiting them. Although the invention is described in detail with reference to preferred embodiments, those of ordinary skill in the art should understand that modifications or equivalents may be made to the technical method of the invention without departing from the spirit and scope of the technical methods of the invention.

What is claimed is:

1. A float preparation process for high-generation TFT-LCD glass substrates, characterized in that, the process combines multiple process systems, comprising:
batching process: weighing raw materials according to a raw material formula of alkali-free aluminoborosilicate glass, mixing the raw materials, and feeding the raw materials into a melting furnace, wherein the feeding is implemented by way of blowing or vibration to prevent material stagnation or accumulation;
melting process: melting the glass batch into molten glass by a combined heating method of electrode-assisted melting and oxygen-fuel combustion;
clarification and homogenization process: clarifying and homogenizing the molten glass by virtue of a platinum channel composed of a plurality of high-temperature section platinum channels and one low-temperature section platinum channel;
forming process: allowing the molten glass to float on the surface of molten tin to form a continuous glass ribbon, and controlling heating units capable of independent temperature control in the tin bath and the thinning force of miniature edge rollers to thin the glass ribbon into a glass substrate;
annealing process: dividing an annealing furnace into multiple zones, wherein the zones are capable of independent temperature control to anneal the glass substrate; and
grinding process: using three types of grinding pads (i.e., a rough grinding pad, a fine grinding pad and a polishing pad) to grind and polish the glass substrate in turn, wherein a hardness ratio of the rough grinding pad to the fine grinding pad to the polishing pad is 90HD-100HD:60HD-70HD:35HD-40HD; each grinding pad comprises a plurality of polishing surfaces divided by grinding grooves; the grinding surfaces other than those at the edge are square; a width ratio of the grinding surfaces other than those at the edge to the grinding grooves is 1:1-3:1; the grinding pad is assembled on a grinding disc, and a round chamfer is formed on the periphery of a side of the grinding disc facing the grinding pad, the periphery of the grinding pad is close to the grinding disc, and a straight chamfer is formed on the periphery of a side of the grinding pad far away from the grinding disc; the angle of the chamber on the grinding disc is greater than or equal to the angle of the chamber on the grinding pad, and the angle of the chamber on the grinding disc is greater than or equal to 60°.

2. The float preparation process for high-generation TFT-LCD glass substrates according to claim 1, characterized in that, in the batching process, the raw material formula comprises: SiO₂: 60-72%; Al₂O₃: 13-18%; B₂O₃: 8.5-10%; MgO: 1-4.5%; CaO: 3-8%; SrO: 1-5%; ZrO₂: 0.5-2%; P₂O₅: 1-5%; SnO₂: 0.1-0.5%, wherein the amount of SiO₂+Al₂O₃ is 76-85%; the amount of (MgO+CaO+SrO)/Al₂O₃ is 0.4-0.7%; the total amount of alkaline earth metal oxides is 5-11.5%; the amount of B₂O₃/(B₂O₃+ZrO₂+P₂O₅) is 0.6-0.9%; the amount of (ZrO₂+P₂O₅)/(MgO+CaO+SrO) is 0.15-0.8%; the sum of each component is 100%, wherein the boron volatilization rate of the mixed material is less than 11%; the raw materials are weighed according to said raw material formula, and during the feeding process, the materials retained on an inner wall of a scale bucket are discharged simultaneously through the blowing of air nozzles arranged on the inner wall of the scale bucket and the vibration of an pneumatic hammer arranged on an outer wall of the scale bucket; a plurality of air nozzles are provided according to a material accumulation situation.

3. The float preparation process for high-generation TFT-LCD glass substrates according to claim 1, characterized in that, in the melding process, the raw materials are heated and melted by electrodes arranged on the inner walls of the melting furnace on two sides or at the bottom of the melting furnace and oxygen-fuel combustion spray guns arranged on the roof or breast wall of the melting furnace; a bubbling device and a furnace sill are arranged in the melting furnace.

4. The float preparation process for high-generation TFT-LCD glass substrates according to claim 1, characterized in that, the low-temperature section platinum channel comprises a stirring device and a plurality of grilles; the installation angles of adjacent grills are different, causing misalignment of holes in the adjacent grills; the stirring effect of the stirring device and the turbulence formed by the multiple grilles achieve full homogenization of molten glass.

5. The float preparation process for high-generation TFT-LCD glass substrates according to claim 1, characterized in that, in the forming process, a lateral temperature difference of the tin bath is adjusted by controlling the output power of the heating units in a lateral direction, and the thinning force of the miniature edge rollers arranged correspondingly to the same lateral positions of the heating units is coordinately adjusted, so that the glass ribbon is thinned and formed.

6. The float preparation process for high-generation TFT-LCD glass substrates according to claim 1, characterized in that, in the annealing process, ceramic rollers serve as transfer rollers to convey the glass substrates; in at least part of an annealing area in the annealing furnace, the temperature of subzones corresponding to edges of the glass substrate is higher than the temperature of the subzones corresponding to the center of the glass substrate, and the thermal conductivity of a thermal insulation material applied to an inner high-temperature layer of at least part of the furnace wall is lower than that of a thermal insulation material applied to an outer low-temperature layer.

7. The float preparation process for high-generation TFT-LCD glass substrates according to claim 1, characterized in that, in the grinding process, the hardness ratio of the rough grinding pad:the fine grinding pad:the polishing pad is selected to be 90HD-95HD:60HD-70HD:35HD-40HD.

8. The float preparation process for high-generation TFT-LCD glass substrates according to claim 7, characterized in that, in the grinding process, the hardness ratio of the rough grinding pad:the fine grinding pad:the polishing pad is selected to be 90HD-95HD:65HD-70HD:35HD-40HD.

9. The float preparation process for high-generation TFT-LCD glass substrates according to claim 7, characterized in that, the angle of the chamber on the grinding disc is greater than or equal to the angle of the chamber on the grinding pad, and the angle of the chamber on the grinding disc is greater than or equal to 60° but less than or equal to 75°.
